(19) United States
(12) Patent Application Publication
(10) Pub. No.: US 2019/0389694 A1
(43) Pub. Date: Dec. 26, 2019

(54) ELEVATOR SYSTEM

(71) Applicant: Otis Elevator Company, Farmington, CT (US)

(72) Inventors: Peter Herkel, Berlin (DE); Jan Ruhnke, Berlin (DE); Dirk H. Tegtmeier, Berlin (DE); Bernd Fischer, Berlin (DE)

(21) Appl. No.: 16/445,920

(22) Filed: Jun. 19, 2019

(30) Foreign Application Priority Data
Jun. 22, 2018 (EP) 18179332.4

(51) Int. Cl. B66B 5/00; B66B 5/04; B66B 1/34; B66B 5/16

(52) U.S. Cl. CPC B66B 5/0031; B66B 5/04; B66B 5/16; B66B 5/005; B66B 1/3492

(57) ABSTRACT

An elevator system (2) comprises a hoistway (4) extending between a plurality of landings (8a, 8b, 8c); an elevator car (60) configured for moving in two opposite directions along the hoistway (4); and an elevator safety system (1). The elevator safety system (1) comprises at least one safety gear (20) configured for moving along the hoistway (4) and, upon activation, braking movement the elevator car (60); at least one mobile safety node (43, 45) configured for moving along the hoistway (4) with the at least one safety gear (20) and for controlling the at least one safety gear (20); and at least one stationary safety node (42, 44). The elevator safety system (1) further comprises a communication bus (17) connecting the safety nodes (42-45) with each other and allowing the safety nodes (42-45) to communicate with each other.

### FOREIGN PRIORITY

This application claims priority to European Patent Application No. 18179332.4, filed Jun. 22, 2018, and all the benefits accruing therefrom under 35 U.S.C. § 119, the contents of which in its entirety are herein incorporated by reference.

### BACKGROUND

The invention relates to an elevator system with an elevator safety system.

An elevator system typically comprises at least one elevator car moving along a hoistway between a plurality of landings, and a driving member configured for driving the elevator car.

An elevator system usually further comprises an elevator safety system configured for monitoring and checking the operation of the elevator system in order to stop any further operation of the elevator system, in particular any movement of the elevator car, in case an unsafe condition of the elevator system is detected. Unsafe conditions of the elevator system in particular may include situations in which a person, such as a mechanic, enters the hoistway for maintaining and/or repairing the elevator system.

It would be beneficial to provide an elevator safety system which facilitates maintaining and repairing the elevator system without deteriorating the safety of the elevator system.

### BRIEF DESCRIPTION

According to an exemplary embodiment of the invention, an elevator system comprises a hoistway extending between a plurality of landings, an elevator car configured for moving in two opposite directions along the hoistway, and an elevator safety system. The elevator safety system comprises at least one safety gear configured for moving along the hoistway and, upon activation, braking movement the elevator car; at least one mobile safety node (mobile safety circuit) configured for moving along the hoistway and for controlling the at least one safety gear; at least one stationary safety node (stationary safety circuit) located within or next to the hoistway; and a communication bus connecting the safety nodes with each other and allowing the safety nodes to communicate with each other.

Exemplary embodiments of the invention also include a method of operating an elevator system according to an exemplary embodiment of the invention, wherein the method includes at least two safety nodes, in particular at least one stationary safety node and one mobile safety node, communicating with each other via the communication bus.

In an elevator safety system according to an exemplary embodiment of the invention, the communication of the at least two safety nodes via the communication bus allows controlling the at least one safety gear remotely. Controlling the at least one safety gear remotely allows adjusting the activation of the at least one safety gear to the current needs, in particular to the currently selected mode of operation of the elevator system. Thus, when the elevator system is operated in a maintenance mode, the at least one safety gear may be controlled/activated differently than during normal operation. This allows facilitating the maintenance work without deteriorating the safety of the maintenance personnel.

A number of optional features are set out in the following. These features may be realized in particular embodiments, alone or in combination with any of the other features, unless explicitly stated otherwise.

The at least one elevator safety gear and the at least one mobile safety node may be mounted to the elevator car for effectively braking the elevator car when activated.

The elevator system may comprise a counterweight moving concurrently and in opposite direction with respect to the elevator car. In such an elevator system, at least one elevator safety gear and at least one mobile safety node may be mounted to the counterweight for braking the counterweight, and, in consequence, also the elevator car.

The elevator system may comprise a position sensor connected to the communication bus and configured for detecting the position of the elevator car within the hoistway. As a result, the activation of the at least one safety gear may be triggered based on the position of the elevator car. The at least one safety gear in particular may be triggered in case the elevator car approaches an upper or lower end of the hoistway so that the distance between the elevator car and the upper or lower end of the hoistway becomes smaller than a predefined limit.

The position sensor may be part of an absolute position reference system including the position sensor and a coded tape (not shown) extending along the length (height) of the hoistway. In such a configuration, the position sensor is configured for interacting with the code tape for determining the position of the elevator car within the hoistway. The coded tape may be coded mechanically, optically, and/or magnetically. Such a configuration allows determining the position of the elevator car with high accuracy.

The elevator system may comprise a speed and/or acceleration sensor connected to the communication bus and configured for detecting the speed and/or the acceleration of the elevator car. As a result, the activation of the at least one safety gear may be triggered based on the speed and/or acceleration of the elevator car. The at least one safety gear in particular may be triggered in case speed and/or acceleration of the elevator car exceeds a predetermined limit.

The position sensor and the speed and/or acceleration sensor may be configured for directly detecting the position, speed and/or acceleration of the elevator car. Alternatively, the position sensor and the speed and/or acceleration sensor may be configured for detecting the position, speed and/or acceleration of the counterweight allowing determining the position, speed and/or acceleration of the elevator car from the detected position, speed and/or acceleration of the elevator car of the counterweight.

For example, an absolute position sensor or an absolute position sensor system may be used for detecting the absolute position of the elevator car within the hoistway, while speed and/or acceleration of the elevator car may be determined from a car position signal by first and second derivatives of the position signal with respect to time, respectively.

The communication bus may be a serial bus, in particular a serial field bus, e.g. a CAN bus. In order to ensure a safe and reliable communication between the safety nodes, the stationary and mobile safety nodes may communicate over the serial bus using a communication protocol which fulfills the IEC 61784-3 safety standard.

The elevator system may further comprise a safety controller, wherein the at least one stationary safety node is connected with the safety controller allowing the safety controller to communicate via the communication bus. The at least one stationary safety node also may be integrated into the safety controller. The at least one stationary safety node and the safety controller in particular may be associated with, or included in, an emergency and inspection control unit (“E & I panel”). The emergency and inspection control unit may be accessible from outside the hoistway.

The safety controller may be configured for controlling an elevator drive and/or a brake provided at the elevator drive. The brake may act on an output shaft of the elevator drive or on a drive sheave mounted to the output shaft. The safety controller in particular may be configured for controlling the elevator drive and/or the brake provided at the elevator drive via the stationary safety node assigned to the safety controller.

For facilitating maintenance of the elevator system by allowing a mechanic to send control commands from the lower end, in particular from the pit, of the hoistway to the safety controller, the elevator system may comprise a stationary safety node which is located at the lower end of the hoistway and connected to the communication bus.

For facilitating maintenance of the elevator system by allowing a mechanic to send control commands from the top of the elevator car, to the safety controller, the elevator system may comprise a mobile safety node, which is located on top, in particular on the roof, of the elevator car and connected to the communication bus.

The safety controller may be switchable between a plurality of operating modes for adjusting the operation of the safety controller to the needs associated with different modes of operation of the elevator system.

The safety controller in particular may be switchable between a normal operation mode, i.e. a mode for transporting passengers and/or cargo between the landings, and at least one operating mode (maintenance mode) which is activated for performing repair and/or maintenance work. The safety controller further may be switchable between a plurality of different maintenance modes respectively associated with different kinds of maintenance.

The plurality of operating modes may comprise at least one operating mode setting at least one predefined upper positional limit and/or at least one predefined lower positional limit. In these operating modes, the safety controller is configured for activating a safety gear when the absolute position of the elevator car exceeds the predefined upper positional limit and/or when the absolute position of the elevator car falls below the predefined lower positional limit. Such operating modes ensure predefined minimum distance between the elevator car and the upper and lower ends of the hoistway, respectively, forming a refuge space for a mechanic working within the hoistway on top or below the elevator car.

The plurality of operating modes in particular may comprise at least one below the car inspection mode setting only a lower positional limit and/or at least one top of car inspection mode setting only an upper positional limit, and/or at least one operating mode setting an upper positional limit and a lower positional limit.

The safety controller may further comprise at least one learning mode configured for setting the upper positional limit and/or the lower positional limit during a learning run in which the elevator car moves along the hoistway.

The safety controller may be configured for determining the speed of the elevator car, e.g. by means of a speed sensor or by differentiating the positional information provided by the position sensor, and activating a safety gear when the speed of the elevator car exceeds a predetermined speed limit. The predetermined speed limit may be set as a function of the currently selected operating mode and/or as a function of the position of the elevator car within the hoistway.

The safety controller may be configured for determining the acceleration of the elevator car, e.g. by means of an acceleration sensor or by differentiating the speed information provided by a speed sensor, and activating a safety gear when the acceleration of the elevator car exceeds a predetermined acceleration limit. The predetermined acceleration limit may be set as a function of the currently selected operating mode and/or as a function of the position of the elevator car within the hoistway.

### DRAWING DESCRIPTION

In the following, exemplary embodiments of the invention are described in more detail with respect to the enclosed figures:

FIG. 1 schematically depicts an elevator system according to an exemplary embodiment of the invention.

FIG. 2 schematically depicts an elevator safety system according to an exemplary embodiment of the invention.

### DETAILED DESCRIPTION

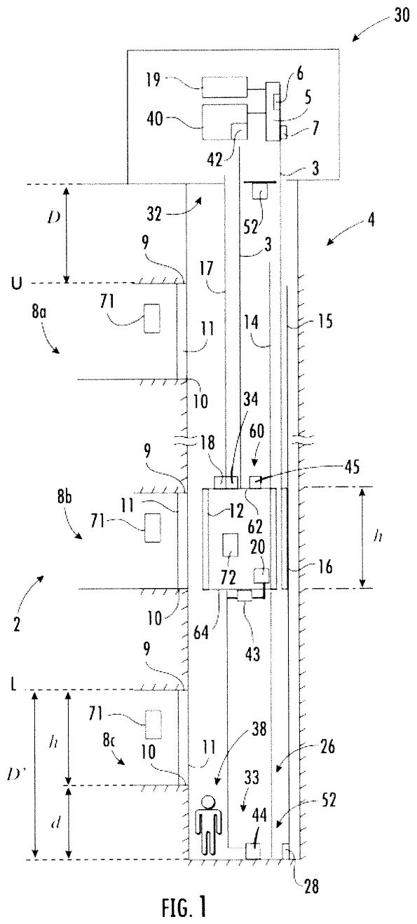

FIG. 1 schematically depicts an elevator system 2 according to an exemplary embodiment of the invention.

The elevator system 2 includes an elevator car 60 movably arranged within a hoistway 4 extending between a plurality of landings 8a, 8b, 8c. The elevator car 60 in particular is movable along at least one car guide member 14 (guide rail), extending along the vertical direction of the hoistway 4. Although only one elevator car 60 is depicted in FIG. 1, the skilled person will understand that exemplary embodiments of the invention may include elevator systems 2 having a plurality of elevator cars 60 moving in one or more hoistways 4.

The elevator car 60 is movably suspended by means of a tension member 3. The tension member 3, for example a rope or belt, is connected to an elevator drive 5. The elevator drive 5 comprises a motor 6 and is configured for driving the tension member 3 in order to move the elevator car 60 along the height of the hoistway 4 between the plurality of landings 8a, 8b, 8c, which are located on different floors.

Each landing 8a, 8b, 8c is provided with a landing door 11, and the elevator car 60 is provided with a corresponding elevator car door 12 for allowing passengers to transfer between a landing 8a, 8b, 8c and the interior of the elevator car 60 when the elevator car 60 is positioned at the respective landing 8a, 8b, 8c.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The elevator system 2 includes further a counterweight 16 attached to the tension member 3 opposite to the elevator car 60 and moving concurrently and in opposite direction with respect to the elevator car 60 along at least one counterweight guide member 15. At least one buffer 28 may be provided within a pit 26 formed at a lower end 33 of the hoistway 4.

The skilled person will understand that the invention may be applied to elevator systems 2 which do not comprise a counterweight 16 as well.

The tension member 3 may be a rope, e.g. a steel wire rope, or a belt, e.g. a coated steel belt. The tension member 3 may be uncoated. Alternatively, the tension member may have a coating, e.g. in the form of a polymer jacket. In a particular embodiment, the tension member 3 may be a belt comprising a plurality of polymer coated steel cords (not shown). The elevator system 2 may have a traction elevator drive including a traction sheave for driving the tension member 3. In an alternative configuration, which is not shown in the figures, the elevator system 2 may be an elevator system 2 without a tension member 3, comprising e.g. a hydraulic elevator drive, friction wheels, or a linear elevator drive. The elevator drive 5 may be installed in a machine room 30 provided next to an upper end 32 of the hoistway 4. Alternatively, the elevator system 2 may be a machine room-less elevator system 2, e.g. an elevator system 2 in which the elevator drive 5 is located within the hoistway 4. The elevator drive 5 also may be accommodated in a cabinet (not shown) provided in the surroundings of the hoistway 4. The cabinet, for example may be attached to or enclosed in a landing door 11.

For moving the elevator car 60 along the hoistway 4 between the different landings 8a, 8b, 8c, the elevator drive 5 is controlled by an elevator controller 19.

Control commands may be input into the elevator controller 19 via landing control panels 71 provided on each of the landings 8a, 8b, 8c, in particular close to the landing doors 11, and/or via an elevator car control panel 72 provided inside the elevator car 60.

An elevator brake 7 configured for braking the movement of the elevator car 60 along the hoistway 4 may be provided next to or integrally with the elevator drive 5.

The elevator system 2 comprises at least one position sensor 18 configured for determining the position of the elevator car 60 within the hoistway 4.

The position sensor 18 may be part of an absolute position reference system, e.g. including the position sensor 18 and a coded tape (not shown) extending along the length (height) of the hoistway 4. In such a configuration, the position sensor 18 is configured for interacting with the code tape for determining the position of the elevator car 60 within the hoistway 4. The coded tape may be coded mechanically, optically, and/or magnetically.

Alternatively or additionally, other types of position sensors 18 may be employed.

The elevator system 2 further comprises a speed and/or acceleration sensor 34 configured for detecting the speed and/or acceleration of the elevator car 60 when moving along the hoistway 4. The speed and/or acceleration sensor 34 may be attached to the elevator car 60. The speed and/or acceleration sensor 34 may be formed integrally with, or separately from, the position sensor 18. The speed and/or acceleration sensor 34 in particular may be configured to use the position information provided by the position sensor 18 for determining the speed of the elevator car 60.

Alternatively or additionally, speed and/or acceleration information provided by the speed and/or acceleration sensor 34 may be used for determining the position of the elevator car 60.

In addition or alternatively to the speed and/or acceleration sensor 34 mounted to the elevator car 60, a speed and/or acceleration sensor (not shown) may be provided at the elevator drive 5 for determining the speed of the elevator car 60 by detecting the speed of the tension member 3 at the elevator drive 5.

The landing control panels 71, the elevator car control panel 72, the position sensor 18 and the speed and/or acceleration sensor 34 may be connected with the elevator controller 19 by electrical wires (not shown in FIG. 1), in particular by an electric bus. Alternatively or additionally, wireless data connections may be used for transmitting information from the control panels 71, 72 and/or the sensors 18, 34 to the elevator controller 19.

At least one of the elevator car 60 and the counterweight 16 is equipped with at least one safety gear 20. The at least one safety gear 20 includes at least one engagement member (not shown) configured for engaging with the respective guide member 14, 15 for braking any movement of the elevator car 60 and/or of the counterweight 16, respectively.

As the counterweight 16, if present, is connected with the elevator car 60 by the tension member 3 so that it moves concurrently and in opposite direction with respect to the elevator car 60, braking the movement of the counterweight 16 by the at least one safety gear 20 also brakes the movement of the elevator car 60.

The at least one safety gear 20 may include a bidirectional safety mechanism (not shown) which is capable to brake the movement of the elevator car 60 in both directions. Alternatively, the safety gear 20 may include at least two unidirectional safety mechanisms, with each unidirectional safety mechanism being configured for braking the movement of the elevator car 60 when moving in one direction, respectively.

In the exemplary embodiment depicted in FIG. 1, a safety gear 20 is mounted to the elevator car 60. Alternatively or additionally, at least one safety gear 20 may be attached to the counterweight 16. For clarity of the illustration, a safety gear 20 mounted to the counterweight 16 is not depicted in FIG. 1.

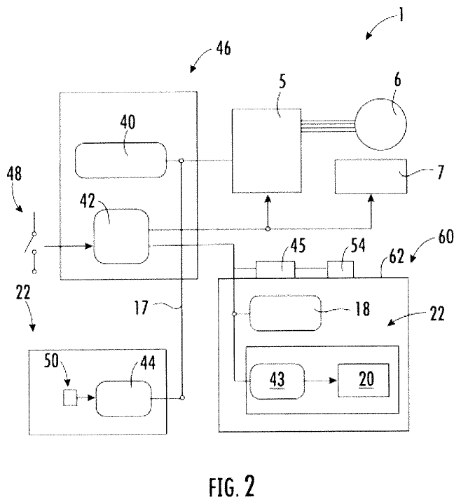

The at least one safety gear 20 is part of an elevator safety system 1. An exemplary embodiment of such an elevator safety system 1 is schematically depicted in FIG. 2.

In addition to the at least one safety gear 20, the elevator safety system 1 comprises at least one mobile safety node 43, 45 mounted to the elevator car 60, and at least one stationary safety node 42, 44 located within or next to the hoistway 4, in particular in the machine room 30, if present. The elevator safety system 1 further comprises a communication bus 17 connecting the stationary and mobile safety nodes 42, 43, 44, 45 with each other in order to allow the stationary and mobile safety nodes 42, 43, 44, 45 to communicate with each other.

The mobile safety node 43 attached to the elevator car 60 is connected to and configured for controlling the at least one safety gear 20 of the elevator car 60.

In a configuration (not shown) in which at least one safety gear 20 is provided at the counterweight 16, a mobile safety node is provided at the counterweight 16 for controlling said safety gear 20.

The at least one safety gear 20 and the associated mobile safety node 43 may be formed integrally as an electronic safety actuator (ESA) 22 (see FIG. 2).

The stationary safety node 42 is connected to a safety controller 40 which is configured for monitoring the operation of the elevator system 2. The stationary safety node 42 may be integrated into the safety controller 40. The stationary safety node 42 allows the safety controller 40 to safely communicate with the mobile safety node 43 attached to the elevator car 60 and/or with further stationary or mobile safety nodes 44, 45 (see FIG. 1) of the elevator safety system 1. The safety controller 40 and the stationary safety node 42 may be provided on a common printed circuit board (PCB) forming a safety actuation board (SAB) within an emergency and inspection control unit 46 (E&I unit) (see FIG. 2).

The stationary safety node 42 may receive input signals from landing door switches 48, each of the landing door switches 48 being assigned to one of the landing doors 11 and configured for monitoring whether the respectively assigned landing door 11 is properly closed or not. Only one landing door switch 48 is exemplarily shown in FIG. 2.

The position sensor 18 and the optional speed and/or acceleration sensor 34 are also connected to the communication bus 17 allowing them to send their signals indicating the position, speed and/or acceleration of the elevator car 60 via the communication bus 17 to the stationary safety node 42 connected with the safety controller 40. As a result, the safety controller 40 is capable of continuously monitoring the position, speed and/or acceleration of the elevator car 60 based on the signals provided by the position sensor 18 and the speed and/or acceleration sensor 34 via the communication bus 17.

The safety controller 40 in particular may trigger the elevator brake 7 and/or the at least one safety gear 20 in case at least one of the detected position, speed and/or acceleration of the elevator car 60 exceeds a predetermined limit and/or at least one of the landing doors 11 is not properly closed.

The limits of the position, the speed and/or the acceleration of the elevator car 60 may depended on the current mode of operation of the elevator system 2. The safety controller 40 in particular may be switchable between a normal operation mode, i.e. a mode for transporting passengers and/or cargo between the landings 8a, 8b, 8c, and at least one operating mode (maintenance mode) which is activated for performing repair and/or maintenance work.

The safety controller 40 may be switchable between a plurality of operating modes. The plurality of operating modes in particular may include one or more of the following modes:

A “top of car default mode”, in which the elevator car 60 is stopped and the at least one engagement member of the at least one safety device is released but not tripped. Once said top of car default mode is established, the tripping speed is decreased, in order to reduce the likelihood of damaging or wearing out the guide rails 14, 15 and the at least one engagement member. It further reduces shock loads acting on the structure of the elevator car 60.

This mode is usually active, when one of the landing doors 11 except for the landing door 11 at the lowermost landing 8c has been opened in normal (non-maintenance) operation. A detection element may be provided in an unlocking device of the landing door 11 in addition to a mandatory landing door switch 48 linked to the door lock. The elevator system 2 is usually operated in the “top of car default mode” right before a mechanic 38 (see FIG. 1) intending to climb onto the roof 62 of the elevator 60 establishes a maintenance mode.

A “top of car access mode”. The “top of car access mode” may be activated by sending a certain signal, for example via a smart wireless device, to the safety controller 40. Upon receipt of said signal, the elevator car 60 is moved to and stopped at a desired landing 8a, 8b, 8c in particular in a position allowing easy access to the roof 62 of elevator car 60. In order to ensure safety, the at least one safety gear 20 is activated releasing the at least one engagement member after the movement of the elevator car 60 has been stopped.

In a “normal inspection mode” mode, the elevator car 60 may move between a lower positional limit L and an upper positional limit U (see FIG. 1) corresponding to different heights of the elevator car 60 within the hoistway 4. The elevator car 60, however, is not allowed to move into restricted areas next to the upper and lower ends 32, 33 of the hoistway 4.

The top (roof 62) of the elevator car 60 in particular has to stay in a predefined minimum distance D from the upper end 32 (ceiling) of the hoistway 4 for providing a space of refuge above the elevator car 60. When the position sensor 18 is arranged on top of the elevator car 60, as in the embodiment depicted in FIG. 1, the upper positional limit U, for example, may correspond basically with the height of a lintel 9 of the landing door 11 of the uppermost landing 8a. The tripping speed of the at least one engagement member may be decreased when the safety controller 40 is operated in the “normal inspection mode”.

Similarly, the bottom (floor 64) of the elevator car 60 has to stay in a predefined minimum distance (height) d from the lower end 33 of the hoistway 4 for providing a space of refuge below the elevator car 60. When the position sensor 18 is arranged on top of the elevator car 60, the height h of the elevator car 60 needs to be taken into account when setting the lower positional limit L. Thus, the lower positional limit L needs to be set to a distance D′=d+h from the bottom 33 of the lower end 33 of the hoistway 4, e.g. to a position basically corresponding with the height of the lintel 9 of the landing door 11 at the lowermost landing 8c.

The skilled person understands that the upper and lower positional limits U, L need to be set differently when the position sensor 18 is arranged below the elevator car 60 or at a vertical position in between the roof 62 and the floor 64 of the elevator car 60.

In a “long hoistway mode”, the inspection speed is increased when at least one inspection mode button (not shown) is pressed for a predetermined time period, e.g. for a plurality of seconds. This allows moving the elevator car 60 over some distance along a comparatively long hoistway 4 in a short period of time.

In a “top landing door inspection mode”, the elevator car 60 is allowed to reach a position in which the lintel 9 of the landing door 11 at the uppermost landing 8a can be inspected and repaired conveniently. In the “top landing door inspection mode”, the inspection speed, i.e. the speed of the elevator car 60, is decreased, and the at least one engagement member is released every time the elevator car 60 has been stopped.

In a “bottom landing door inspection mode”, the elevator car 60 is allowed to reach a position in which the lintel 9 of the landing door 11 at the lowermost landing 8c can be inspected and repaired conveniently. In the “bottom landing door inspection mode”, the inspection speed, i.e. the speed of the elevator car 60, is decreased, and the at least one engagement member is released every time the elevator car 60 has been stopped.

In a “top of hoistway inspection mode”, the elevator car 60 may reach a position in which components 52 of the elevator system 2 installed at the upper end 32 of the hoistway 4 can be inspected and repaired conveniently. In the “top of hoistway inspection mode”, the inspection speed is decreased, and the at least one engagement member is released every time the elevator car 60 has been stopped.

The plurality of operating modes may further include pit access and inspection modes designated to be activated for accessing components 52, such as a buffer 28 (see FIG. 1), of the elevator system 2 located below the elevator car 60, in particular within the pit 26 formed at the lower end 33 of the hoistway 4.

The pit access and inspection modes in particular may include one or more of the following modes:

A “pit access and inspection default mode”, in which the elevator car 60 is stopped and not allowed to move below the sill 10 of the landing door 11 at the lowermost landing 8c. This mode is activated when a landing door 11 providing access to the pit 26 is opened while the elevator system 2 is operated in a normal operation (non-maintenance) mode. In addition to a mandatory switch linked to the door lock, a detection element may be provided in a door unlocking device of the landing door 11. The “pit access and inspection default mode” is the status of the system right before a mechanic 30 activates a maintenance mode for entering into the pit 26.

A “pit work mode”, in which the elevator car 60 and the counterweight 16 are sent to positions allowing components 52 of the elevator system 2 located in the pit 26 to be inspected and/or repaired. In the “pit work mode”, the at least one engagement member is released as soon as the elevator car 60 has been stopped.

A “counterweight inspection mode”, in which the elevator car 60 is moved to the upper end 33 of the hoistway 4 until the counterweight 16 rests on the at least one buffer 28 provided within the pit 26. The at least one engagement member is released as soon as the elevator car 60 and the counterweight 16 have been stopped in said configuration.

A “bottom of car inspection mode”, in which the elevator car 60 is allowed to move with a reduced speed while a mechanic 38 is present in the pit 26. The elevator car 60 is stopped by tripping the at least one engagement member allowing the mechanic 30 to inspect and/or repair the floor 64 and/or components 52 of the elevator system 2 mounted to the bottom of the elevator car 60.

The maximum speed of the elevator car 60 in particular may be reduced to 0.7 m/s in one of the inspection modes, and the maximum speed of the elevator car 60 may be reduced even further to 0.4 m/s in case a mechanic 30 is present within the pit 26 and/or on the roof 62 of the elevator car 60.

Further operating modes may comprise acceleration limits limiting the maximum allowable acceleration of the elevator car 60 within the hoistway 4. I.e. in such an operating mode, the elevator brake 7 and/or the at least one safety gear 20 is activated, when the actual acceleration of the elevator car 60 exceeds a predetermined acceleration limit.

At the beginning, e.g. in the factory, the upper and lower positional limits U, L as well as the speed and/or acceleration limits may be set to preliminary values.

At least some of these limits may be adjusted in a learning run performed after the installation of the elevator system 2. During such a learning run, the elevator car 60 is moved along the hoistway 4, and the upper and/or lower positional limits U, L is set, e.g. by pressing an assigned button, when the elevator car 60 passes or reaches a position corresponding to the respective limit. During such a learning run, the elevator car 60 may move at a lower speed than in normal operation.

Similarly, the elevator car 60 may be accelerated during the learning run, and a maximum speed and/or a maximum acceleration may be set when the corresponding speed and/or acceleration has been reached, respectively.

For facilitating maintenance work performed at the bottom 33 of the hoistway 4, the elevator system 2 may comprise an additional stationary safety node 44 arranged at the lower end 33, in particular within the pit 26, of the hoistway 4. The additional stationary safety node 44 may be connected to the communication bus 17 and to a pit control device 50. Such a configuration allows a mechanic 30 to control the safety controller 40 by sending control commands, which are input into the pit control device 50, via the communication bus 17 from the lower end 33/pit 26 of the hoistway 4 to the safety controller 40.

Additionally or alternatively, the elevator system 2 may further comprise an additional mobile safety node 45 provided on the roof 62 of the elevator car 60. The additional mobile safety node 45 is connected to the communication bus 17 and to a roof control device 54 (see FIG. 2). Providing a roof control device 54 and a mobile safety node 45 on the roof 62 of the elevator car 60 facilitates maintenance work performed on the roof 62 of the elevator car 60 as it allows sending control commands, which are input into the roof control device 54, from the roof 62 of the elevator car 60 to the safety controller 40.

The elevator controller 19, the safety controller 40, the safety nodes 42, 43, 44, 45, and/or the electronic safety actuator 22 may be provided as programmable electronic safety boards (PES) comprising a programmable micro-processor running an appropriate software program for providing the desired functionalities. Alternatively or additionally, the elevator controller 19, the safety controller 40, the safety nodes 42, 43, 44, 45, and/or the electronic safety actuator 22 may be implemented in hardware, i.e. as an electronic circuit. This in particular may include an application-specific integrated circuit (ASIC) customized to the respective functionalities.

For ensuring a safe and reliable communication between the safety nodes 42, 43, 44, 45, the communication bus 17 may be a serial bus, in particular a serial field bus using a communication protocol fulfilling the IEC 61784-3 safety standard, “Industrial communication networks—Profiles—Part 3: Functional safety fieldbuses—General rules and profile definitions”. The design of the hardware and software of the safety nodes 42, 43, 44, 45 may conform with the IEC 61508 “Functional safety of electrical/electronic/programmable electronic safety-related systems”, and the safety gears may conform with the elevator code EN81-20.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

1 elevator safety system

2 elevator system

3 tension member

4 hoistway

5 elevator drive

6 motor

7 elevator brake

8a, 8b, 8c landing

9 lintel

10 sill

11 landing door

12 elevator car door

14 car guide member

15 counterweight guide member

16 counterweight

17 communication bus

18 position sensor

19 elevator controller

20 safety gear

22 electronic safety actuator

26 pit

28 buffer

30 machine room

32 upper end of the hoistway

33 lower end of the hoistway

34 speed and/or acceleration sensor

38 mechanic

40 safety controller

42 stationary safety node

43 mobile safety node

44 stationary safety node

45 mobile safety node

46 emergency and inspection control unit

48 landing door switch

50 pit control device

52 component of the elevator system

54 roof control device

60 elevator car

62 roof of the elevator car

64 floor of the elevator car

66 car side wall

68 interior space of the elevator car

71 landing control panel

72 elevator car control panel

D minimum distance of the upper positional limit from the upper end of the hoistway

D′ minimum distance of the lower positional limit from the lower end of the hoistway

d minimum distance of the bottom of the elevator car from the lower end of the hoistway

h height of the elevator car

L lower positional limit

U upper positional limit

What is claimed is:

1. An elevator system (2) comprising:
a hoistway (4) extending between a plurality of landings (8a, 8b, 8c);
an elevator car (60) configured for moving in two opposite directions along the hoistway (4); and
an elevator safety system (1) comprising:
at least one safety gear (20) configured for moving along the hoistway (4) and, upon activation, braking movement of the elevator car (60);
at least one mobile safety node (43, 45) configured for moving along the hoistway (4) with the at least one safety gear (20) and for controlling the at least one safety gear (20);
at least one stationary safety node (42, 44); and
a communication bus (17) connecting the safety nodes (42-45) with each other and allowing the safety nodes (42-45) to communicate with each other.

2. The elevator system (2) according to claim 1, wherein the at least one elevator safety gear (20) and the at least one mobile safety node (43, 45) are mounted to the elevator car (60).

3. The elevator system (2) according to claim 1, further comprising a counterweight (16) moving concurrently and in opposite direction with respect to the elevator car (60); wherein the at least one elevator safety gear (20) and the at least one mobile safety node (43, 45) are mounted to the counterweight (16).

4. The elevator system (2) according to claim 1, further comprising a position sensor (18) connected to the communication bus (17) and configured for detecting the position of the elevator car (60) within the hoistway (4).

5. The elevator system (2) according to claim 1, further comprising a speed and/or acceleration sensor (34) connected to the communication bus (17) and configured for detecting the speed and/or the acceleration of the elevator car (60).

6. The elevator system (2) according to claim 1, wherein the communication bus (17) is a serial bus, in particular a serial field bus, wherein in particular the stationary and mobile safety nodes (42-45) use a communication protocol fulfilling the IEC 61784-3 safety standard for communicating over the serial bus.

7. The elevator system (2) according to claim 1, further comprising a safety controller (40), wherein the at least one stationary safety node (42, 44) is connected with the safety controller (40), or integrated into the safety controller (40), allowing the safety controller (40) to communicate via the communication bus (17), wherein the at least one stationary safety node (42, 44) and the safety controller (40) in particular are associated with, or included in, an emergency and inspection control unit (46).

8. The elevator system (2) according to claim 7, wherein the safety controller (40) is configured for controlling an elevator drive (5) and/or an elevator brake (7) provided at the elevator drive (5), wherein the safety controller (40) in particular is configured for controlling the elevator drive (5) and/or the elevator brake (7) provided at the elevator drive (5) via the stationary safety node (42, 44) assigned to the safety controller (40).

9. The elevator system (2) according to claim 7, further comprising a stationary safety node (44) located at a lower end (33) of the hoistway (4) and being connected to the communication bus (17) in order to allow sending control commands to the safety controller (40), and/or further comprising a mobile safety node (45) located on top of the elevator car (60) and being connected to the communication bus (17).

10. The elevator system (2) according to claim 7, wherein the safety controller (40) is switchable between a plurality of operating modes.

11. The elevator system (2) according to claim 10,
wherein the plurality of operating modes comprise at least one operating mode setting at least one predefined upper positional limit (U) and/or at least one predefined lower positional limit (L); and
wherein the safety controller (40) is configured for activating a safety gear (20) when the absolute position of the elevator car (60) exceeds the predefined upper positional limit (U) and/or when the absolute position of the elevator car (60) falls below the predefined lower positional limit (L).

12. The elevator system (2) according to claim 11, wherein the plurality of operating modes comprise at least one below the car inspection mode setting only a lower positional limit (L) and/or at least one top of car inspection mode setting only an upper positional limit (U), and/or at least one operating mode setting an upper positional limit (U) and a lower positional limit (L).

13. The elevator system (2) according to claim 11, wherein the safety controller (40) comprises at least one learning mode configured for setting the upper positional limit (U) and/or the lower positional limit (L) during a learning run in which the elevator car (60) moves along the hoistway (4).

14. The elevator system (2) according to claim 11, wherein the safety controller (40) is configured for determining the speed of the elevator car (60) and activating a safety gear (20) when the speed of the elevator car (60) exceeds a predetermined speed limit, and wherein the predetermined speed limit is set as a function of the currently selected operating mode and/or as a function of the position of the elevator car (60) within the hoistway (4).

15. A method of operating an elevator system (2) according to claim 1, wherein the method includes the at least one mobile safety node (43, 45) and the at least one stationary safety node (42, 44) communicating with each other via the communication bus (17).
